(19) United States
(12) Patent Application Publication
(10) Pub. No.: US 2016/0217139 A1
(43) Pub. Date: Jul. 28, 2016

(54) DETERMINING A PREFERRED LIST LENGTH FOR SCHOOL RANKING

(71) Applicant: LinkedIn Corporation, Mountain View, CA (US)

(72) Inventors: Navneet Kapur, Sunnyvale, CA (US); Ryan Wade Sandler, San Francisco, CA (US); Nikita Igorevych Lytkin, Sunnyvale, CA (US); Bee-Chung Chen, San Jose, CA (US); Deepak Agarwal, Sunnyvale, CA (US)

(21) Appl. No.: 14/606,944

(22) Filed: Jan. 27, 2015

(51) Int. Cl. G06F 17/30; G06Q 50/20; G06Q 10/10

(52) U.S. Cl. CPC G06F 17/3053; G06F 17/30312; G06F 17/30707; G06Q 10/10; G06Q 50/2053

(57) ABSTRACT

A school ranking system may be configured to determine a rank of a school based on career outcomes data. Career outcomes data is obtained, at least in part, from member profile data stored by an on-line social network system. The school ranking system uses a list of the top-ranked companies for generating ranking data and also determines how many companies are to be included in the list of the top-ranked companies.

### TECHNICAL FIELD

This application relates to the technical fields of software and/or hardware technology and, in one example embodiment, to system and method to determine a preferred list length for school ranking.

### BACKGROUND

Since the beginning of time people have been asking what is the best university and found some sort of responses in publications such as “US News and World Report,” “Times Higher Education,” in various academic rankings of the world, etc. While various existing rankings are out there, many are all based on data such as reputation surveys, faculty resources, admission scores, admittance rate, which often resemble self-reinforcing popularity contests. One example is a school ranking based on the admittance rate: the higher a school is in the ranking, the more students are likely to apply to that school; the more students applying to a school, the lower is the admittance rate, which in itself boosts the school's ranking.

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be include one or more web pages, or a structured representation of the member's information in XML (Extensible Markup Language), JSON (JavaScript Object Notation), etc. A member's profile web page of a social networking web site may emphasize employment history and education of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example school ranking system may be implemented;

FIG. 2 is block diagram of a system to determine a preferred list length for school ranking, in accordance with one example embodiment;

FIG. 3 is a flow chart of a method to determine a preferred list length for school ranking, in accordance with an example embodiment.

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to determine a preferred list length for school ranking is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). The profile information of a social network member may include personal information such as, e.g., the name of the member, current and previous geographic location of the member, current and previous employment information of the member, information related to education of the member, information about professional accomplishments of the member, publications, patents, etc. The profile information of a social network member may also include information about the member's professional skills, such as, e.g., “product management,” “patent prosecution,” “image processing,” etc.). The profile of a member may also include information about the member's current and past employment, such as company identifications, professional titles held by the associated member at the respective companies, as well as the member's dates of employment at those companies.

School ranking, such as, e.g., the ranking of higher education institutions, is extremely important not only to prospective students, who are in the process of choosing a university to attend, but also to parents, alumni, educators, as well as to employers. One perceived reason that perspective students may be choosing to go to a higher ranked university is that they wish to get a good job upon graduation and to be able to earn more money. One approach to determining a rank for a higher education institution, which may also be referred to as merely a school or a university, relies on the assumption that school A should be ranked higher than school B if the graduates of school A tend to obtain jobs at more desirable or higher ranking companies than the graduates of school B. A methodology for ranking universities may leverage information maintained in the member profiles of an on-line social network, e.g., information related to members' education and employment.

According to one example embodiment, universities may be ranked on the basis of proportions of their graduates who obtained employment at some of the most desirable companies for a given profession or occupation (e.g., software developer). As this methodology may be based on occupation rather than industry, the companies included in the set of desirable companies for a particular occupation may be from a mix of industries. The methodology is designed to account for a possibility that not all graduates of a university have an interest in the same occupation. This may be achieved by only considering a subpopulation, further referred to as a cohort, of the university's graduates who attained a degree in a particular field of study or a position in a particular occupational area. The success scores for universities are generated using proportions of graduates within the cohorts, who attained positions at some of the top companies for the corresponding occupation. The success scores may be organized into categories, with each category corresponding to a different occupation. For the purposes of this description, a category corresponding to an occupation may be referred to as a ranking category. Prior to the generating of the success scores for a university, one type of bias correction may be applied to cohort counts using gender and graduation year data in order to account for potential under-representation of universities' graduates in an on-line social network that is being used to obtain data related to education and employment of the universities' graduates. Such potential under-representation may occur, e.g., due to the fact that some graduates may not be members of the on-line social network.

Desirable companies for each ranking category may be identified using patterns of transitions between companies by members in the occupational area corresponding to the ranking category. In one embodiment, this approach may also factor in retention dynamics within companies. For example, companies with stronger employee retention and greater inflow of talent may be deemed more desirable. Because tenure dynamics may vary across ranking categories, raw retention statistics are normalized within each ranking category in order to keep the influence of retention on company desirability consistent across categories. Furthermore, transition statistics may be normalized for company size in order to bring companies of varying sizes on a level field when estimating desirability. In addition, the fact that a company's desirability may change over time may be accounted for by only considering career transitions occurring within the past few years (e.g., within the past 5 years). Company desirability may be expressed by a so-called desirability score, which may be determined using Page Rank algorithm applied to a career transition graph, whose vertices correspond to companies and whose edges represent transition and retention patterns discussed above. Each company in a set of companies may be represented by a company identification and an associated desirability score. Based on their respective desirability scores, a number of top-ranked companies may be designated as the set of desirable companies for a given ranking category, which can be subsequently utilized to produce university success scores and rankings.

In some embodiments, it may be desirable to determine how many top-ranked companies should be included in the list of desirable companies. While a longer list may produce more stable university rankings, increasing list length also results in less desirable companies being included in the set of top companies. At the same time, a shorter list may be a more accurate representation of desirable companies, but result in less stable university rankings. The specific number of companies to be used in the process of ranking universities with respect to a particular ranking category may be determined based on analysis of stability of university success scores generated with respect to moderate (e.g., 5-10%) random perturbations to the set of desirable companies while using different list lengths of the desirable companies set. A size of the desirable companies set achieving highest stability may be chosen for each category.

Various metrics may be used to determine stability. These metrics could be list-wise or pair-wise. In one example embodiment, a customized list-wise metric is utilized, which is a linear combination of normalized agreement@3, agreement@5, agreement@10, and agreement@25 values. For example, given two perturbed university rankings set A and set B, where the top three schools in the set A are S1, S2, S4 and the top three schools in the set B are S2, S1, S3, the normalized agreement@3 value is 0.67, since two schools in the sets A and B overlap and the number of overlapping schools (two) is divided by the total number of schools being considered in calculating the agreement (three). In some embodiments, the normalized agreement@5 and agreement@10 values may be assigned the highest weight by design.

In a further embodiment, a size of a desirable companies set may be determined by first generating respective sets of ranks for universities using desirable companies sets of different sizes, and then evaluating variances between these resulting sets of ranks as related to increasing a number of items in respective sets of desirable companies.

The process of generating university rankings using perturbed sets of desirable companies is described below.

In order to make university rankings robust to potential noise in the data that reflects company desirability, a large number of perturbed sets of desirable companies are generated by repeatedly substituting a randomly chosen subset (e.g., 5-10%) of companies from the desirable companies set with the same number of companies selected from outside of the desirable companies set. In one embodiment, the methodology may be designed to avoid complimentary values of the percent of perturbation and the selected percentile ranks. For example, where the 95^{th} percentile ranks is to be selected, the perturbation may be performed with respect to 7.5% of the top-ranked companies. Each perturbed set of desirable companies is used to produce a respective university ranking for each university in a set of schools that are being ranked (also referred to as a set of subject schools). For each university, the above procedure results in a distribution over ranks the university attained across perturbed sets of desirable companies. A certain percentile rank (e.g., the 95-th percentile rank) from this distribution is then taken as the ranking statistic for the university. If two or more universities have the same certain percentile rank, a lower percentile rank is used (e.g., if two or more universities have the same 95-th percentile rank, their respective 75-th percentile ranks are used to resolve ties). Universities with the same higher and lower selected percentile ranks are declared tied and are assigned the same final rank. An alternative to percentile ranks is to use other statistics such as mean rank, or a lower or upper bound of a confidence interval for the mean rank to produce the final ranking of universities. Another approach is to use the distribution over not ranks but rather the success scores calculated for the university across the perturbed sets, next determine the final success score from the distribution (e.g., by using percentiles, mean or other statistics as described above), and then do the ranking of universities as the final step.

An approach where a school rank is determined based on a great number of perturbed sets of desirable companies may be beneficial in producing a more accurate rank for a school that may be a feeder school for one particular company (or a few specific companies), such that the rank for that school would depend greatly on whether that particular company or these few specific companies make it into the list of most desirable companies.

For the purposes of this description, a computer-implemented system for determining respective ranks for schools represented by items in an electronically-stored set (a set of subject schools) may be referred to as a school ranking system. A school ranking system may be configured to determine the success score of a school and the ranking of the school with respect to other schools, based on so-called career outcomes data. Career outcomes data may be obtained from member profile data stored by an on-line social network system that focuses on professional profiles of its members. Member profiles in an on-line social network system, together with the associated data, may include information, such as a university attended by a member represented by a member profile, a type of degree obtained by the member at that university, whether the member had an internship and at which company, when and at which company the member got their first job, etc.

In order to determine a success score for a particular school—referred to as a target school—a school ranking system may examine member profiles representing respective members of the on-line social network system to determine how many of the target school alumni can be considered successful alumni. Successful alumni, for the purposes of this description, are those that obtained employment at one of the top-ranked companies. In one embodiment, a school ranking system may access or extract education data and employment data from member profiles maintained by an on-line social network system. Education data, that may be found in the education section of a member profile, may then be used to determine a set of profiles—termed an alumni set of profiles—that include data that indicate that the respective members represented by the profiles in the alumni set of profiles are alumni of the target school. Employment data, that may be found in the experience section of a member profile, may then be used to determine another set of profiles—termed a successful alumni set of profiles—that include data that indicate that the respective members represented by the profiles in the successful alumni set of profiles are those alumni of the target school that that obtained employment at one of the top-ranked companies. In one embodiment, the profiles selected by the school ranking system to be included in the successful alumni set of profiles are those profiles that indicate that an alumnus represented by the member profile obtained employment at one of the top-ranked companies within a certain number of years post-graduation. In another embodiment, successful alumni may be identified as those that obtained a position at or higher than a certain seniority level and/or at one of the companies in the set of top-ranked companies. The top-ranked companies (also referred as desirable companies) may be represented by respective items in an electronically-stored list of company identifications. An optimal (or merely desirable) number of items in a list of top-ranked companies may be determined by evaluating stability with respect to ranking data generated using lists of top ranked companies having different numbers of items. A school ranking system may be configured include one or more modules for determining a desirable number of items in a list of top-ranked companies.

As explained above, a school ranking system utilizes a list of top-ranked (also termed desirable) companies to calculate respective success scores for schools in a set of subject schools. A success score for a school may be calculated as a number of successful alumni (e.g., based on the company they are employed at and, in some cases, their job seniority) divided by the total number of the school's alumni. The number of successful alumni of a target school may be determined by determining the number of profiles in the successful alumni set of profiles. The number of total alumni of a target school may be determined by counting the number of profiles in the alumni set of profiles or by obtaining this information from other sources, such as, e.g., from a third-party database.

A success score for a school (also referred to as merely a score) may be calculated as an overall success score or as a success score for a particular field of study, for a particular industry, such as, e.g., computer science, finance, architecture, etc., or a particular occupation (e.g., information technology or consulting). When a score for a school is being calculated for a particular field of study or for a particular occupation, the school ranking system may utilize a list of companies associated with that particular field of study or occupation.

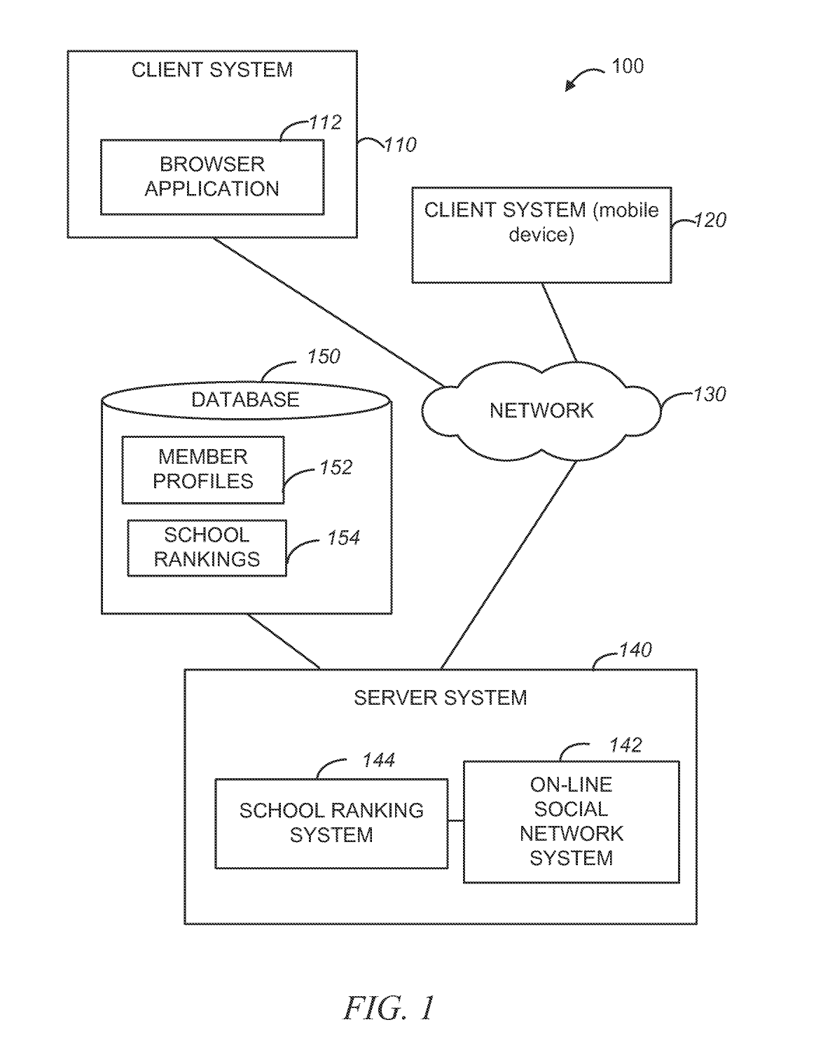

A success score for a school and/or its ranking with respect to other schools may be stored in a database for future use. In one embodiment, the school ranking system may generate a presentation screen that includes an identification of a school together with an associated success score and/or the ranking. A school ranking system may be configured to cause the presentation screen to be rendered on a display device of a user. Example school ranking system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a school ranking system 144 that may be utilized beneficially to determine respective success scores for higher education institutions referred to as schools for the sake of brevity. The school ranking system 144 may be configured to determine a ranking of a school based on career outcomes data, which may be obtained from member profile data stored by the on-line social network system 142. The school ranking system 144 may examine the member profiles and determine how many of the target school alumni can be considered successful alumni. The school ranking system 144 may then calculate a success score for a school as a number of successful alumni divided by the total number of the school's alumni.

As explained above, in order to make university rankings robust to potential noise in company desirability (e.g., where a school may have many of its graduates join one or a few specific companies) the school ranking system 144 may be configured to determine a rank for a school based on a great number of perturbed sets of desirable companies. A perturbed set of desirable companies may be generated by substituting a subset (e.g., 5-10%) of companies from the set of desirable companies with companies outside that set. Companies from outside of the set of desirable companies may be chosen randomly, or, e.g., based on the companies' respective desirability scores. The school ranking system 144 may then use each of the perturbed sets to produce a rank for each school in a set of subject schools. The distribution of the ranks calculated for a particular school with respect to the multitude of the perturbed sets of desirable companies is used to determine the ranking statistic for the university. Respective ranking statistics calculated for schools in the set of subject schools are used to rank the schools in the set of subject schools.

As mentioned above, success scores for a school may be calculated as overall success scores or as success scores for a particular field of study or for a particular occupation. For example, the score for Stanford University in the field of computer science may be calculated as the number of successful alumni (the number of people who attended Stanford University, received a degree in computer science from Stanford University, and obtained a job at one of the most highly-ranked companies (at a company from a set of desirable companies), divided by the total number of candidates. The candidates may be people who attended Stanford University and indicated their interest in pursuing a particular occupation. An indication of an interest in pursuing a particular occupation may be manifested in the member profile by a reference to a degree in a particular field (e.g., computer science) or, e.g., by employment in a particular role (e.g., software engineer).

When a score for a school is being calculated for a particular field of study or for a particular occupation, the school ranking system may utilize a list of companies associated with that particular field of study or occupation. Respective success scores, as well as ranks, calculated by the school ranking system 144 for various schools may be stored in the database 150, as school rankings 154.

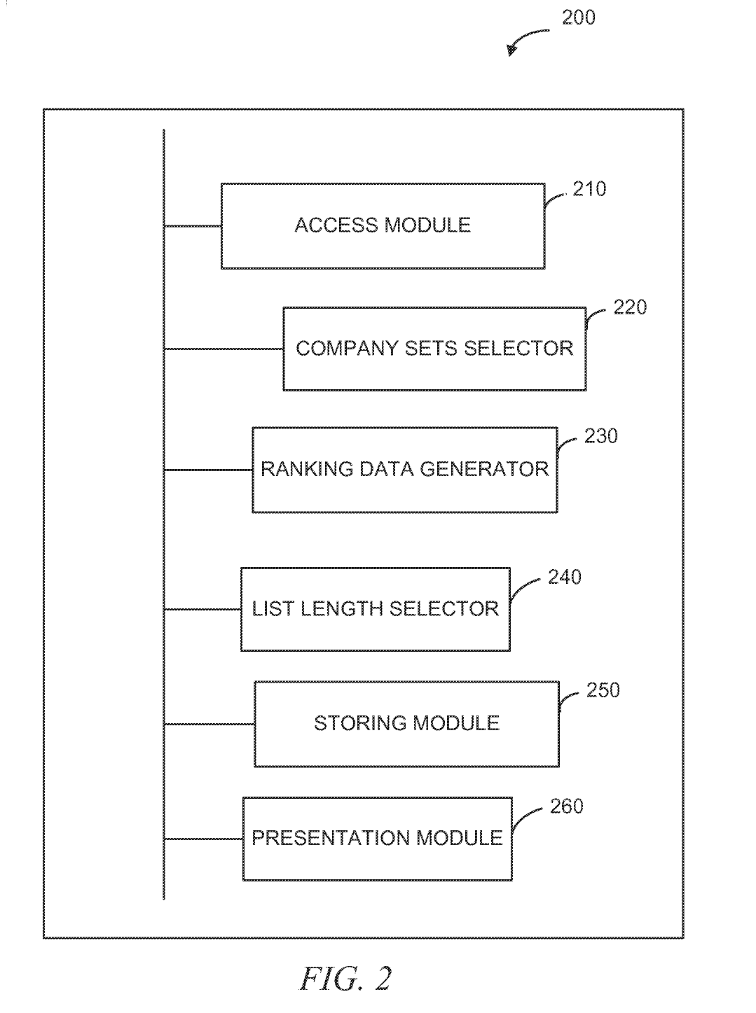

The school ranking system 144 may also be configured to determine an optimal or desirable number of companies to be utilized in the process of generating university rankings for a particular ranking category. As explained above, in one embodiment, a desirable number of companies may be determined based on analysis of stability of university success scores generated with respect to moderate random perturbations to the set of desirable companies while using different list lengths of the desirable companies set. A size of the desirable companies set achieving highest stability may be chosen for each category. In a further embodiment, the school ranking system 144 may determine a size of a desirable companies set (also referred to as a list length of a desirable companies set) by first generating respective sets of ranks using desirable companies sets of different sizes, and then evaluating variances between the sets of ranks as related to increasing a number of items in respective sets of desirable companies. A value corresponding to the size of the desirable companies set may be stored in the database 150 and may be retrieved at a later time. An example school ranking system 144 is illustrated in FIG. 2.

FIG. 2 is a block diagram of a system 200 to determine a preferred list length for school ranking, in accordance with one example embodiment. The system 200 to determine a preferred list length for school ranking may be part of the school ranking system 144 of FIG. 1. As shown in FIG. 2, the system 200 includes an access module 210, a company sets selector 220, a ranking data generator 230, a list length selector 240, and a storing module 250. The access module 210 may be configured to access a set of companies, where each company in the set of companies is associated with a respective desirability score. The set of companies, where each item in the set represents a company and is associated with a respective desirability score, may include only those items that include an indication of a particular occupation (also termed a category). The company sets selector 220 may be configured to select from the set of companies a plurality of sets of desirable companies, each set having a different list length value. For example, the company sets selector 220 may select, from the set of companies associated with a particular ranking category (e.g., finance), a set of 100 top-ranked companies, a set of 200 top-ranked companies, and a set of 500 top-ranked companies.

The ranking data generator 230 may be configured to generate, for each set from the sets of desirable companies having different respective list length values, a respective list length set of ranks, where each list length set of ranks is created with respect to the same set of subject schools. Thus, each list length set of ranks is associated with a different list length value. Based on these list length sets of ranks, the list length selector 240 determines a desirable list length value, which indicates how many items to include in a list of the top-ranked companies. The list length selector 240 may be configured to evaluate stability with respect to data related to the plurality of list length sets of ranks. Based on results of the evaluating, the list length selector 240 selects a final set of ranks from the plurality of list length sets of ranks. The list length value associated with the final set of ranks is identified as a desirable list length value.

A measure of stability with respect to data related to the plurality of list length sets of ranks may be determined using a variety of approaches. For example, the list length selector 240 may evaluate stability with respect to agreement between values within each set of ranks generated for respective perturbed sets of desirable companies. For example, where the test list length are 100, 200, and 300, the length selector 240 may determine that the 5000 sets of school ranks—that resulted from generating ranks using 5000 perturbed versions of the set of 200 top-ranked companies—exhibit greater agreement among themselves as compared to the agreement among the 5000 sets of school ranks that resulted from generating ranks using respective 5000 perturbed versions of set of top-ranked companies having different list lengths. The list length selector 240 then designates the list length of 200 as the desirable list length. As explained above, various metrics may be used to determine stability with respect to rank sets generated using perturbed sets of various lengths. In some embodiments, for every company list-length, averaged agreement is computed. The average is taken over each pair in the set of rankings. In order to address potential computational intensity, parallelizing and effective sharding of the results may be utilized.

The list length selector 240 may apply stability metrics to the plurality of list length sets of ranks generated using sets of desirable companies having different list lengths. In some embodiments, the list length selector 240 evaluates variances between sets in the plurality list length of sets of ranks as related to increasing a number of items in respective sets of desirable companies and selects, as the desirable list length, the value associated with the maximum variance that is below a certain threshold.

The storing module 250 may be configured to store the desirable list length value in a database for future use. For example, the ranking data generator 230 may retrieve the desirable list length value stored in the database, select a number of top-scoring companies from the set of companies that equals the desirable list length value, and generate a set of ranks for the set of subject schools using that number of top-scoring companies.

As explained above, the stability metrics may be applied to perturbed sets of desirable companies. The ranking data generator 230 may be configured to generate a plurality of perturbed sets of desirable companies by repeatedly substituting a randomly chosen subset of companies from the set of desirable companies with companies that are from the set of companies but outside the set of desirable companies. The ranking data generator 230 may be configured to either randomly select the companies that are from the set of companies but outside the set of desirable companies or, in some embodiments, to select such companies based on respective desirability scores of the companies that are outside the set of desirable companies. The ranking data generator 230 may be configured to generate ranking data for a target school in a set of subject schools, based on the plurality of perturbed sets of desirable companies.

Based on the ranking data for a target school, the ranking data generator 230 determines a ranking statistic, which, in turn is used to determine the rank of the target school with respect to other schools in the set of subject schools and the respective ranking statistics determined to the other schools in the set of subject schools. The ranking data for a target school comprises the distribution of values calculated for a target school with respect to each of the plurality of perturbed sets of desirable companies. The ranking data generator 230 may be configured to determine a ranking statistic that represents a certain percentile from the distribution of these values. The ranking data generator 230 may be configured to determine the rank for the target school based on the ranking statistic created for the target school. In one embodiment, the values in the ranking data are school ranks calculated for a target school with respect to each of the plurality of perturbed sets of desirable companies. In a further embodiment, the values in the ranking data are success scores calculated for a target school with respect to each of the plurality of perturbed sets of desirable companies.

In order to generate success scores, the ranking data generator 230 selects a set of alumni profiles from a plurality of member profiles, where each profile from the set of alumni profiles includes data indicating that a member represented the profile graduated from the target school identified by a target school identifier. In one embodiment, the ranking data generator 230 selects for inclusion into the set of alumni profiles only those profiles that include data indicating that a member represented the profile is engaged in or is interested in a certain field of study or occupation. As explained above, the methodology for correcting bias in determining a school rank utilizes on-line social network data, and thus a member profile from the plurality of member profiles represents a member of the on-line social network system. The ranking data generator 230 examines profiles in the set of alumni profiles in order to identify profiles for inclusion in a set of successful alumni profiles. Each profile from the set of successful alumni profiles includes data indicating that a member represented by the profile from obtained employment at a company represented by an item in a set from the plurality of perturbed sets of desirable companies. The ranking data generator 230 next calculates a success score for the target school. The success score may be calculated as a number of items in the set of successful alumni profiles divided by a number of alumni of the target school. The ranking data generator 230 may also be configured to account for possible representation biases stemming from some graduates not being represented in the on-line social network.

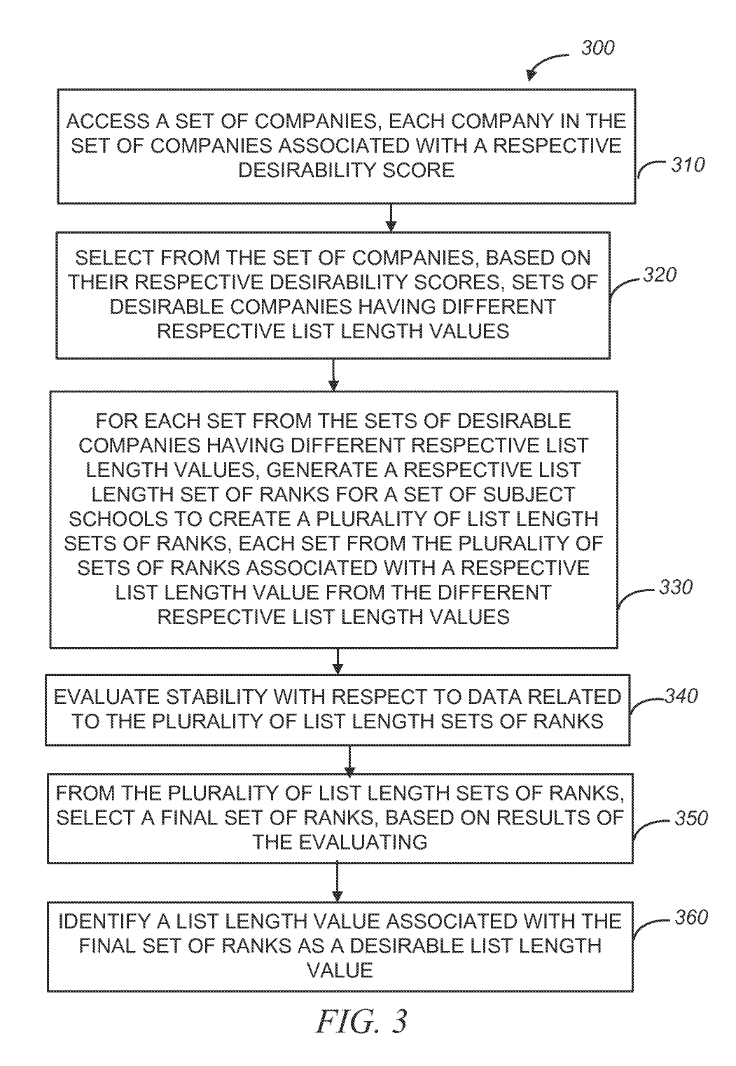

The system 200 may also include a presentation module 260. The presentation module 260 may be configured to cause presentation of a rank on a display device as associated with the target school. For example, the presentation module 260 may generate a presentation screen that includes the rank and/or the ranking statistic, for a particular school. Some operations performed by the system 200 may be described with reference to FIG. 3.

FIG. 3 is a flow chart of a method 300 to determine a preferred list length for school ranking to a social network member, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the access module 210 of FIG. 2 accesses a set of companies, where each company in the set of companies is associated with a respective desirability score. As explained above, the set of companies, where each item in the set represents a company and is associated with a respective desirability score, may include only those items that include an indication of a particular occupation (also termed a category or a ranking category). At operation 320, the company sets selector 220 of FIG. 2 selects, from the set of companies, a plurality of sets of desirable companies, each selected set having a different list length value. At operation 330, the ranking data generator 230 of FIG. 2 generates, for each set from the sets of desirable companies having different respective list length values, a respective list length set of ranks for a set of subject schools to create a plurality of list length sets of ranks. Each set from the plurality of sets of ranks is thus associated with a respective list length value from the different respective list length values.

Based on these list length sets of ranks, the list length selector 240 of FIG. 2 determines a desirable list length value, which indicates how many items to include in a list of the top-ranked companies. At operation 340, list length selector 240 evaluates stability with respect to data related to the plurality of list length sets of ranks. Based on results of the evaluating, the list length selector 240 selects a final set of ranks from the plurality of list length sets of ranks at operation 350. The list length value associated with the final set of ranks is identified as a desirable list length value at operation 360.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

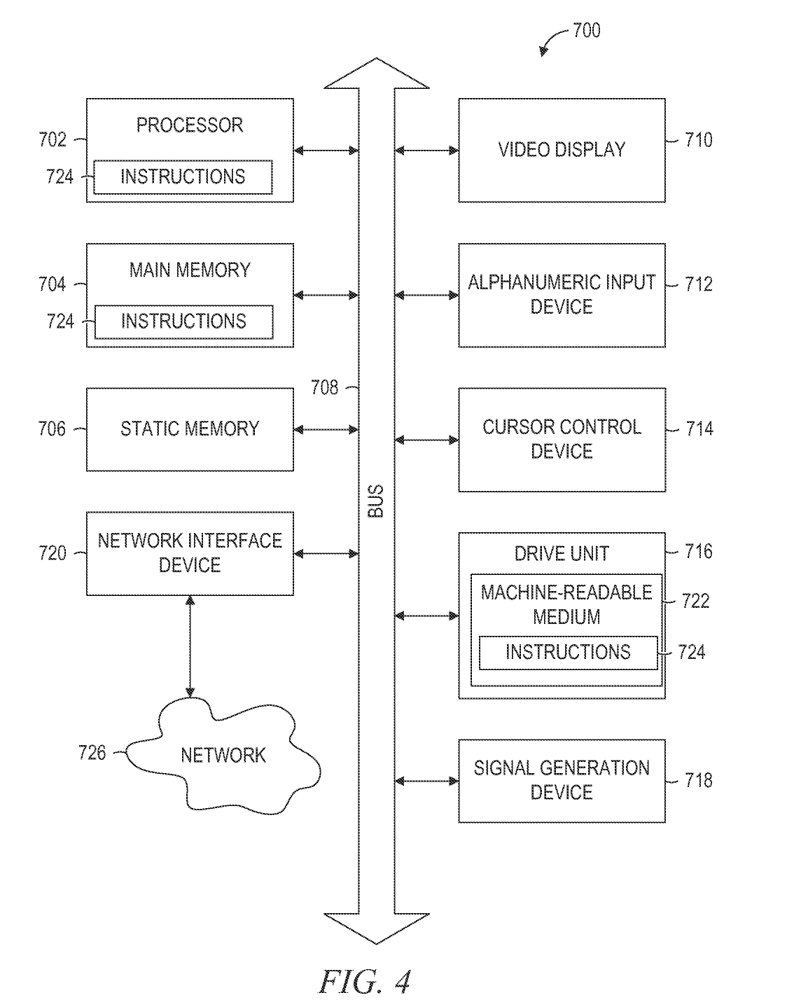

FIG. 4 is a diagrammatic representation of a machine in the example form of a computer system 700 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 707. The computer system 700 may further include a video display unit 710 (e.g., a liquid crystal display (LCD) or a cathode ray tube (CRT)). The computer system 700 also includes an alpha-numeric input device 712 (e.g., a keyboard), a user interface (UI) navigation device 714 (e.g., a cursor control device), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, with the main memory 704 and the processor 702 also constituting machine-readable media.

The software 724 may further be transmitted or received over a network 726 via the network interface device 720 utilizing any one of a number of well-known transfer protocols (e.g., Hyper Text Transfer Protocol (HTTP)).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system to determine a preferred list length for school ranking have been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
accessing a set of companies, each company in the set of companies associated with a respective desirability score;
selecting from the set of companies, based on their respective desirability scores, sets of desirable companies having different respective list length values;
for each set from the sets of desirable companies having different respective list length values, generating a respective list length set of ranks for a set of subject schools to create a plurality of list length sets of ranks, each set from the plurality of sets of ranks associated with a respective list length value from the different respective list length values;
using at least one processor, evaluating stability with respect to data related to the plurality of list length sets of ranks;
from the plurality of list length sets of ranks, selecting a final set of ranks, based on results of the evaluating;
identifying a list length value associated with the final set of ranks as a desirable list length value; and
storing the desirable list length value in a database.

2. The method of claim 1, wherein the generating of a list length set of ranks from the plurality of list length sets of ranks, using a test set from the sets of desirable companies having different respective list length values comprises:
generating a plurality of perturbed sets of the test set by repeatedly substituting a randomly chosen subset of companies from the test set with companies that are from the set of companies but outside the test set;
based on the plurality of perturbed sets of the test, set generating ranking data for each school in the set of subject schools; and
based on the ranking data generated for each school in the set of subject schools, determining the list length set of ranks, the list length set of ranks associated with the test list length value.

3. The method of claim 2, wherein the evaluating of stability with respect to the data related to the plurality of list length sets of ranks comprises:
applying stability metrics to the ranking data generated for each school in the set of subject schools.

4. The method of claim 2, wherein the generating of the ranking data comprises, for each set in the plurality of perturbed sets:
generating respective success scores for each school from the set of subject schools; and
determining respective ranks for each school in the set of subject schools, based on the respective success scores,
wherein the ranking data comprises the respective ranks for each school in the set of subject schools generated for each set in the plurality of perturbed sets.

5. The method of claim 4, wherein the evaluating of stability with respect to the data related to the plurality of list length sets of ranks comprises applying stability metrics to the respective ranks for each school in the set of subject schools generated for each set in the plurality of perturbed sets.

6. The method of claim 1, wherein the evaluating of stability with respect to the data related to the plurality of list length sets of ranks comprises applying stability metrics to the plurality of list length sets of ranks.

7. The method of claim 6, wherein the evaluating of stability with respect to the plurality of list length sets of ranks comprises evaluating variances between sets in the plurality list length of sets of ranks as related to increasing a number of items in respective sets of desirable companies.

8. The method of claim 4, further comprising:
retrieving, from a database, the stored desirable list length value;
from the set of companies, based on their respective desirability scores, selecting a set of top-scoring companies having a number of items that equals the stored desirable list length value; and
generating a set of ranks for the set of subject schools with respect to the set of top-scoring companies.

9. The method of claim 1, comprising selecting a category representing a subject occupation, wherein each item in the set of companies includes an indication of the subject occupation.

10. The method of claim 1, comprising causing presentation, on a display device, of a rank from the final set of ranks as associated with a target school from the set of subject schools.

11. A computer-implemented system comprising:
an access module, implemented using at least one processor, to access a set of companies, each company in the set of companies associated with a respective desirability score;
a company sets selector, implemented using at least one processor, select from the set of companies, based on their respective desirability scores, sets of desirable companies having different respective list length values;
a ranking data generator, implemented using at least one processor, to generate, for each set from the sets of desirable companies having different respective list length values, a respective list length set of ranks for a set of subject schools to create a plurality of list length sets of ranks, each set from the plurality of sets of ranks associated with a respective list length value from the different respective list length values;
a list length selector, implemented using at least one processor, to:
evaluate stability with respect to data related to the plurality of list length sets of ranks,
from the plurality of list length sets of ranks, select a final set of ranks, based on results of the evaluating, and
identify a list length value associated with the final set of ranks as a desirable list length value; and
a storing module, implemented using at least one processor, store the desirable list length value in a database.

12. The system of claim 11, wherein the ranking data generator is to:
generate a plurality of perturbed sets of the test set by repeatedly substituting a randomly chosen subset of companies from the test set with companies that are from the set of companies but outside the test set;
based on the plurality of perturbed sets of the test set, generate ranking data for each school in the set of subject schools; and
based on the ranking data generated for each school in the set of subject schools, determine the list length set of ranks, the list length set of ranks associated with the test list length value.

13. The system of claim 12, wherein the list length selector is to:
apply stability metrics to the ranking data generated for each school in the set of subject schools.

14. The system of claim 12, wherein the ranking data generator is to, for each set in the plurality of perturbed sets:
generate respective success scores for each school from the set of subject schools; and
determine respective ranks for each school in the set of subject schools, based on the respective success scores,
wherein the ranking data comprises the respective ranks for each school in the set of subject schools generated for each set in the plurality of perturbed sets.

15. The system of claim 14, wherein the list length selector is to apply stability metrics to the respective ranks for each school in the set of subject schools generated for each set in the plurality of perturbed sets.

16. The system of claim 11, wherein the list length selector is to apply stability metrics to the plurality of list length sets of ranks.

17. The system of claim 16, wherein the list length selector is to evaluate variances between sets in the plurality list length of sets of ranks as related to increasing a number of items in respective sets of desirable companies.

18. The system of claim 14, wherein the ranking data generator is to:
retrieve, from a database, the stored desirable list length value;
from the set of companies, based on their respective desirability scores, select a set of top-scoring companies having a number of items that equals the stored desirable list length value; and
generate a set of ranks for the set of subject schools with respect to the set of top-scoring companies.

19. The system of claim 11, wherein each item in the set of companies includes an indication of a subject occupation.

20. A machine-readable non-transitory storage medium having instruction data executable by a machine to cause the machine to perform operations comprising:
accessing a set of companies, each company in the set of companies associated with a respective desirability score;
selecting from the set of companies, based on their respective desirability scores, sets of desirable companies having different respective list length values;
for each set from the sets of desirable companies having different respective list length values, generating a respective list length set of ranks for a set of subject schools to create a plurality of list length sets of ranks, each set from the plurality of sets of ranks associated with a respective list length value from the different respective list length values;
evaluating stability with respect to data related to the plurality of list length sets of ranks;
from the plurality of list length sets of ranks, selecting a final set of ranks, based on results of the evaluating;
identifying a list length value associated with the final set of ranks as a desirable list length value; and
storing the desirable list length value in a database.
